(19) United States
(12) Patent Application Publication
(10) Pub. No.: US 2006/0136829 A1
(43) Pub. Date: Jun. 22, 2006

(54) Customizable user interface for exposing customized application functionality sets

(75) Inventors: Mohamed Anas Abbar, Redmond, WA (US); Ziad Khalidi, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/008,054

(22) Filed: Dec. 9, 2004

(51) Int. Cl. G06F 3/00; G06F 17/00; G06F 9/00

(52) U.S. Cl. 715/744

(57) ABSTRACT

A customized user interface for exposing customized application functionality sets is provided. A variety of customized user interface “skins” are provided for selectively overlaying a standard application user interface for hiding unwanted functionality and/or for exposing certain desired or non-standard functionality. While a standard application user interface is overlaid with a customized user interface skin, only the functionality exposed by the customized user interface skin will execute functionality of the associated application. Customized content, including games, educational information, business information and professional information may be provided via the customized user interface skin. A development wizard may be used for creating customized user interface skins or for further customizing customized user interface skins.

### FIELD OF THE INVENTION

The present invention generally relates to computer software application user interfaces. More particularly, the present invention relates to customizable user interfaces for exposing customized application functionality sets.

### BACKGROUND OF THE INVENTION

With the advent of the computer age, computer and software users have grown accustomed to user-friendly software applications that help then write, calculate, organize, prepare presentations, send and receive electronic mail, make music, and the like. For example, modern electronic word processing applications allow users to prepare a variety of useful documents. Modem spreadsheet applications allow users to enter, manipulate, and organize data. Modem electronic slide presentation applications allow users to create a variety of slide presentations containing text, pictures, data or other useful objects.

Often users of such applications have limited ability to use all the available functionality of the applications, or often users need the use of specialized functionality not available by such applications. For example, small children may have limited ability to understand and use many of the different functionalities provided by a word processing application, and often the buttons and other controls provided the user interfaces of such applications may be confusing or even meaningless to a child. On the other hand, a business or other institution, such as a hospital, may need customized features not available in “off-the-shelf” versions of such applications. For example, a sales organization may need functionality from a spreadsheet application, such as a button that launches purchase order templates, that is not available in the “off-the-shelf” version. A hospital may need functionality from a word processing application, such as a drug interaction chart, that is not available in the “off-the-shelf” version of the word processing application.

It is with respect to these and other considerations that the present invention has been made.

### SUMMARY OF THE INVENTION

Embodiments of the present invention solve the above and other problems by providing a customizable user interface for exposing customized application functionality sets. According to one embodiment of the present invention, a variety of customized user interface “skins” are provided for selectively overlaying a standard application user interface for hiding unwanted functionality and/or for exposing certain desired or non-standard functionality. While a standard application user interface is overlaid with a customized user interface skin, only the functionality exposed by the customized user interface skin will execute functionality of the associated application.

According to another embodiment, a given customized user interface skin may provide sample content such as games, educational information, templates or any other content useful by target users of the customized user interface skin.

According to another embodiment of the invention, a user interface skin development wizard is provided. The wizard may be used to create customized user interface skins. The wizard also may be used to add or delete customized functionalities to a user interface skin, or the wizard may be used to make selectable content available through the selection of customized controls added to a given user interface skin.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a block diagram showing the architecture of a personal computer that provides an illustrative operating environment for embodiments of the present invention.

FIG. 2 is an illustration of a computer screen display showing a standard user interface for an example word processing application.

FIG. 3 is an illustration of a computer screen display showing a customized user interface skin overlaying the standard user interface illustrated in FIG. 2 for providing a customized functionality set.

FIG. 4 is an illustration of a computer screen display showing a customized user interface skin overlaying a standard user interface illustrated in FIG. 2 and showing the provision of sample content via the customized user interface skin.

FIG. 5 is an illustration of a computer screen display showing a customized user interface skin overlaying a spreadsheet application user interface and showing sample content provided via the customized user interface skin.

FIG. 6 is an illustration of a computer screen display showing a customized user interface skin overlaying a standard user interface and showing customized functionality sets created and exposed via a development wizard according to embodiments of the present invention.

### DETAILED DESCRIPTION OF THE PREFERRED EMBODIMENT

As briefly described above, embodiments of the present invention are directed to customizable and customized user interfaces for exposing customized application functionality sets and content. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

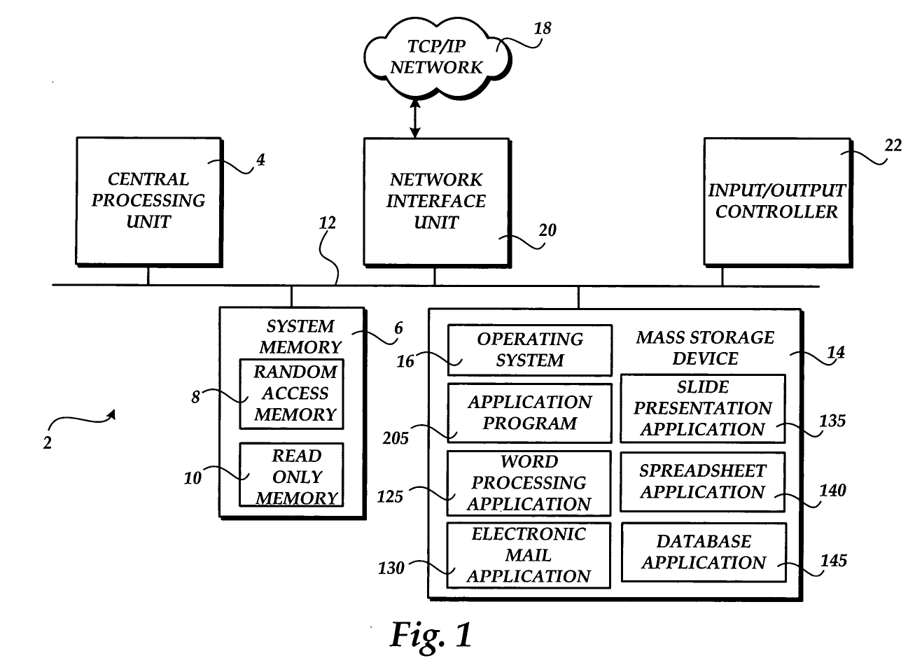

Referring now to the drawings, in which like numerals represent like elements through the several figures, aspects of the present invention and the exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Turning now to FIG. 1, an illustrative computer architecture for a personal computer 2 for practicing the various embodiments of the invention will be described. The computer architecture shown in FIG. 1 illustrates a conventional personal computer, including a central processing unit 4 (“CPU”), a system memory 6, including a random access memory 8 (“RAM”) and a read-only memory (“ROM”) 10, and a system bus 12 that couples the memory to the CPU 4. A basic input/output system containing the basic routines that help to transfer information between elements within the computer, such as during startup, is stored in the ROM 10. The personal computer 2 further includes a mass storage device 14 for storing an operating system 16, application programs, such as the application program 205, and data.

The mass storage device 14 is connected to the CPU 4 through a mass storage controller (not shown) connected to the bus 12. The mass storage device 14 and its associated computer-readable media, provide non-volatile storage for the personal computer 2. Although the description of computer-readable media contained herein refers to a mass storage device, such as a hard disk or CD-ROM drive, it should be appreciated by those skilled in the art that computer-readable media can be any available media that can be accessed by the personal computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the personal computer 2 may operate in a networked environment using logical connections to remote computers through a TCP/IP network 18, such as the Internet. The personal computer 2 may connect to the TCP/IP network 18 through a network interface unit 20 connected to the bus 12. It should be appreciated that the network interface unit 20 may also be utilized to connect to other types of networks and remote computer systems. The personal computer 2 may also include an input/output controller 22 for receiving and processing input from a number of devices, including a keyboard or mouse (not shown). Similarly, an input/output controller 22 may provide output to a display screen, a printer, or other type of output device.

As mentioned briefly above, a number of program modules and data files may be stored in the mass storage device 14 and RAM 8 of the personal computer 2, including an operating system 16 suitable for controlling the operation of a networked personal computer, such as the WINDOWS operating systems from Microsoft Corporation of Redmond, Wash. The mass storage device 14 and RAM 8 may also store one or more application programs. In particular, the mass storage device 14 and RAM 8 may store an application program 105 for providing a variety of functionalities to a user. For instance, the application program 105 may comprise many types of programs such as a word processing application, a spreadsheet application, a desktop publishing application, and the like. According to an embodiment of the present invention, the application program 205 comprises a multiple functionality software application suite for providing functionality from a number of different software applications. Some of the individual program modules that may comprise the multiple functionality application suite 205 include a word processing application 125, a slide presentation application 135, a spreadsheet application 140 and a database application 145. An example of such a multiple functionality application suite 205 is OFFICE manufactured by Microsoft Corporation. Other software applications illustrated in FIG. 1 include an electronic mail application 130.

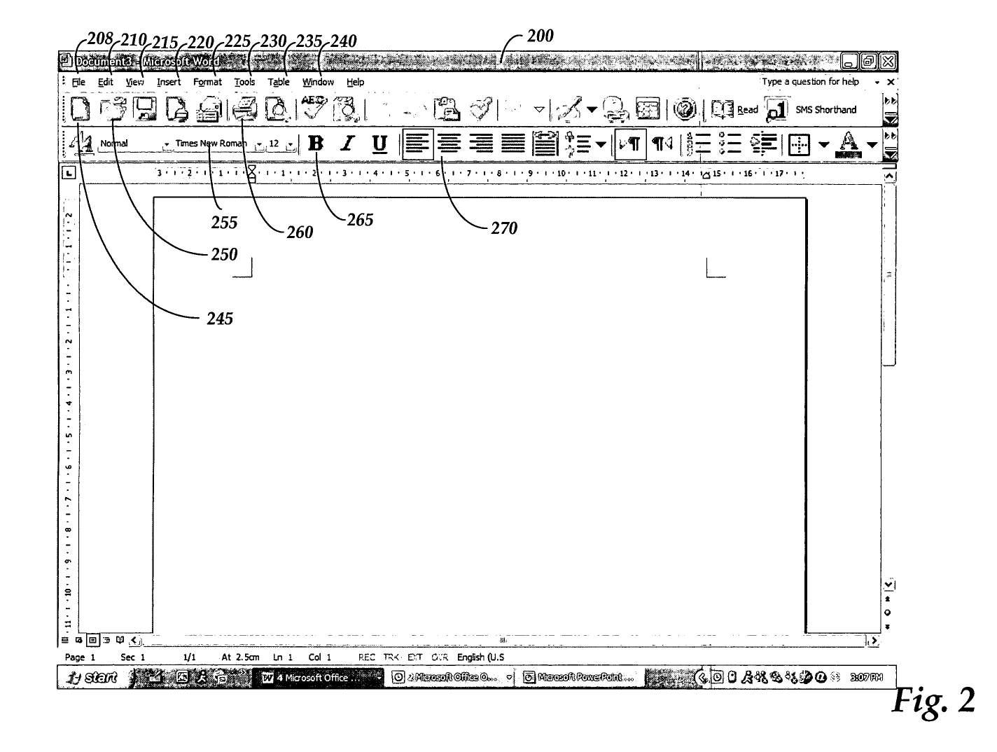

FIG. 2 is an illustration of a computer screen display showing a standard user interface for an example word processing application. As should be understood by those skilled in the art, discussion of the present invention with respect to a particular user interface, such as a word processing application user interface, is for purposes of example only. Embodiments of the present invention are equally applicable to any standard user interface for any application for which a customizable user interface for exposing a customized application functionality set is desired. Referring still to FIG. 2, the user interface 200 has a variety of functionality controls, including the file button 208, the edit button 210, the view button 215, the insert button 220, the format button 225, and the like. Selection of any of these buttons may cause a drop down menu of additional functionality available under the associated example word processing application. Additional functionality controls include the new document control 245, the open document control 250, and the print control 260. Other functionality controls available from the standard user interface 200 include formatting controls, such as the font type control 255, the boldface control 265, and the centered text control 270. The identified controls are for purposes of example and are not limiting of the variety of functionality controls that may be included in the standard user interface 200, illustrated in FIG. 2.

As mentioned above, the application functionality set exposed by the available functionality controls available from the standard user interface 200 may not be useful to certain target users, such as small children. Indeed, many of the functionalities available in the standard functionality set of the user interface 200 may be meaningless to a young child. For example, a young child may wish to type a basic document, but may have no understanding, nor need for such functionalities as font type settings, grammar checkers, and the like. Moreover, in order to entice a young child to use the functionality of the associated application, it may be desirable to provide visual functionality controls that are pleasing to the eye of the child. On the other hand, the standard functionality set provided by the user interface 200 may lack certain customized functionalities required by a business or other institution. For example, as described above, a hospital organization may desire functionality controls in the tool bars of the word processing application user interface 200 for exposing pre-formatted documents, such as drug interaction charts, emergency procedures, hospital personnel scheduling, and the like.

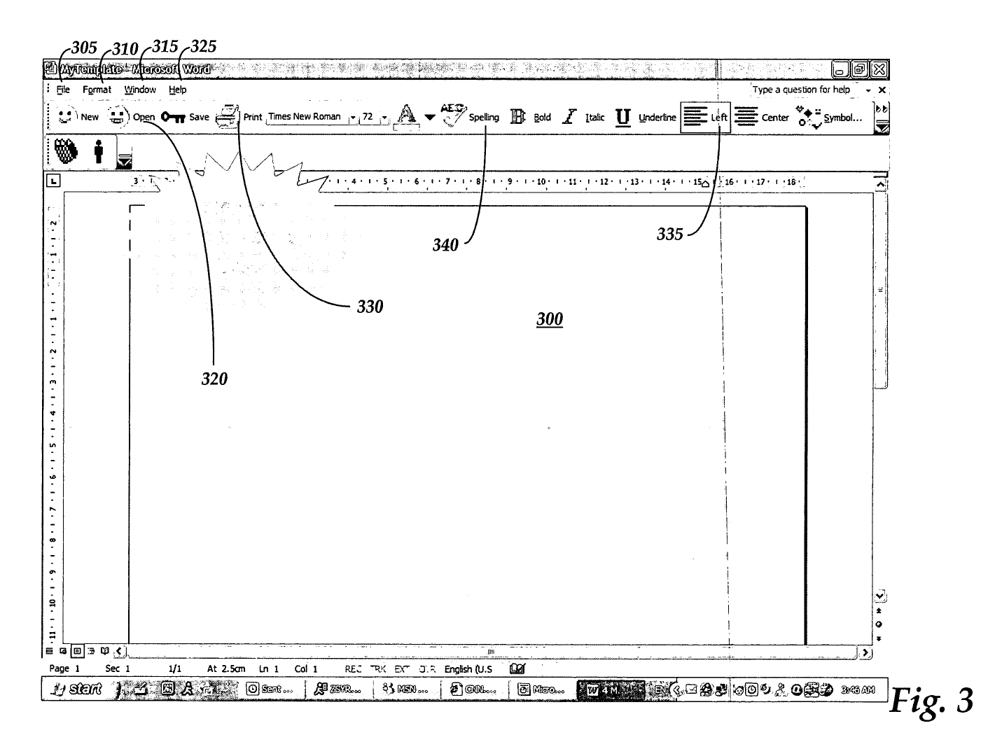

FIG. 3 is an illustration of a computer screen display showing a customized user interface skin overlaying the standard user interface illustrated in FIG. 2 for providing a customized functionality set via a user interface combination comprised of the standard user interface and the overlaying user interface skin. The customized user interface skin 300 overlays the standard user interface 200 illustrated in FIG. 2. The customized user interface skin 300 is an example customized user interface skin for exposing a customized functionality set to a young child, for example, having a male gender. For example, referring to FIG. 3, numerous functionality controls provided in the standard user interface 200, have been hidden from view, and the customized user interface skin 300 has exposed a set of functionality controls that are customized to the age and gender of the target user. For example, the file control, format control, window control, and help control are still available. On the other hand, tools available to the target user have been greatly diminished. For example, a new document control 315, an open document control 320, a save control 325, and a print control 330 are available, but many of the formatting controls available in the standard user interface 200 have been hidden from view and use. In addition, the standard control icons for many of the functionality controls exposed in the standard user interface skin 200 have been replaced with child-friendly icons for making the icons enticing to the target user. For example, the new document control 315 utilizes a “smiley face” icon, instead of the document icon utilized in the standard user interface. A key icon is utilized for the save control 325, as opposed to a diskette icon utilized in the standard user interface.

As should be understood by those skilled in the art, a number of methods may be utilized for providing a customized user interface skin 300 for overlaying the standard user interface 200. For example, the associated software application, for example, a word processing application, may be modified by downloading a software code add-in that will modify the coding of the word processing application to allow for selectively overlaying the standard user interface with the customized user interface skin 300. Such an add-in may be loaded onto a user's computer according to a variety of different means, including a memory device, such as a diskette or CD-ROM, or the add-in may be downloaded from a distributed computing source, such as an Internet-based server. According to an embodiment of the present invention, applying a software code add-in to the associated application for enabling the customized user interface skin 300 may cause the inclusion of a control in the standard functionality control set of the standard user interface 200 for selectively overlaying the standard user interface 200 with the customized user interface skin 300. Likewise, the customized user interface 300 may include a functionality control for switching back to the standard user interface 200 as desired.

As briefly described above, when the customized user interface skin 300 overlays the standard user interface 200, the functionality available from the associated software application, for example, the word processing application, is still available, but is temporarily hidden from view and hidden from use while the customized user interface skin 300 overlays the standard user interface 200. That is, while the customized user interface skin 300 is overlaying the standard user interface 200, only the functionality set exposed by the customized user interface skin 300 is available for use by a user of the associated software application.

As should be understood, a number of different customized user interface skins may be prepared and made available to target users. For example, a user interface skin for kids may be provided, a user interface skin for sales organizations may be provided, a user interface skin for hospitals may be provided, a user interface skin for schools may be provided, a user interface skin for the home may be provided, a user interface skin for senior citizens may be provided, and the like. In each case, a customized set of functionality controls is exposed according to the target users of the given user interface skin. For example, a customized set of functionality controls for senior citizens may include enlarged buttons and controls for ease of reading. As should be understood, the target users or user groups listed herein are for purposes of example only and are not limiting of the number of different types of users or user groups for which one or more customized user interface skins may be provided according to the present invention. Indeed, a customized user interface skin may be generated with a variety of different customized functionality sets according to the needs of any given user or user group.

According to another embodiment of the present invention, a user interface skin development wizard is provided and may be added to the coding of a given software application for allowing a user to create customized user interface skins to provide specific functionality controls and to provide selected content for a desired user interface skin. Similarly, the wizard may be used for further customizing user interface skins. For example, the development wizard may be utilized to further customize an already customized user interface skin to provide additional functionality or content not already available for a given customized user interface skin. As mentioned above, the wizard may be a coding add-in to a given software application, such as a word processing application, spreadsheet application, and the like. On the other hand, the wizard may be a stand-alone software application for creating and/or customizing user interface skins. In either case the coding of the wizard includes sufficient computer-executable instructions for creating and/or customizing user interface skins as described herein.

In use, the development wizard may ask questions to a user in order to help the user in developing or customizing a user interface skin. For example, the wizard may ask an age range for target users of the customized user interface skin. Based on a provided age range, the wizard may suggest functionality controls that should be exposed to the target users. If a customized user interface skin is being developed for a business, the wizard may ask the type of business, for example, sales, manufacturing, service, etc. In response to selection of a particular type of business, the wizard may provide a variety of types of functionalities that may be available, for example, buttons for launching purchase order templates, buttons for lunching tax calculation programs in a spreadsheet application, and the like. Alternatively, the development wizard may be used to expose a variety of functionality controls to further customize or create a user interface skin that is different from any “off-the-shelf” user interface functionality set or from any previously customized user interface skin.

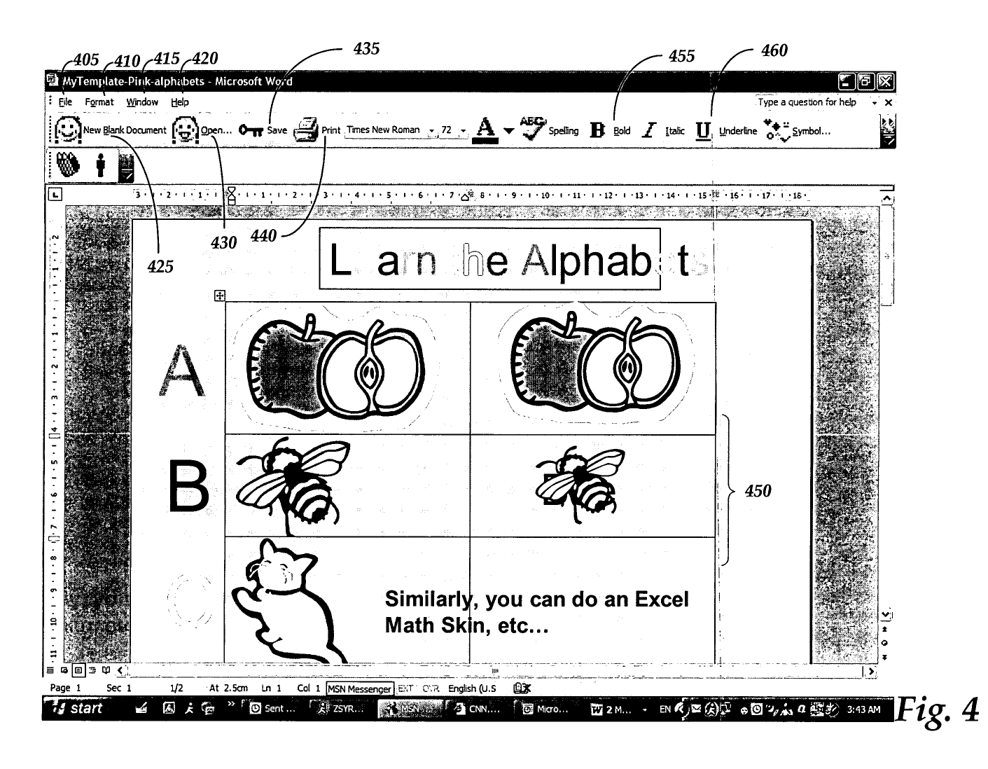

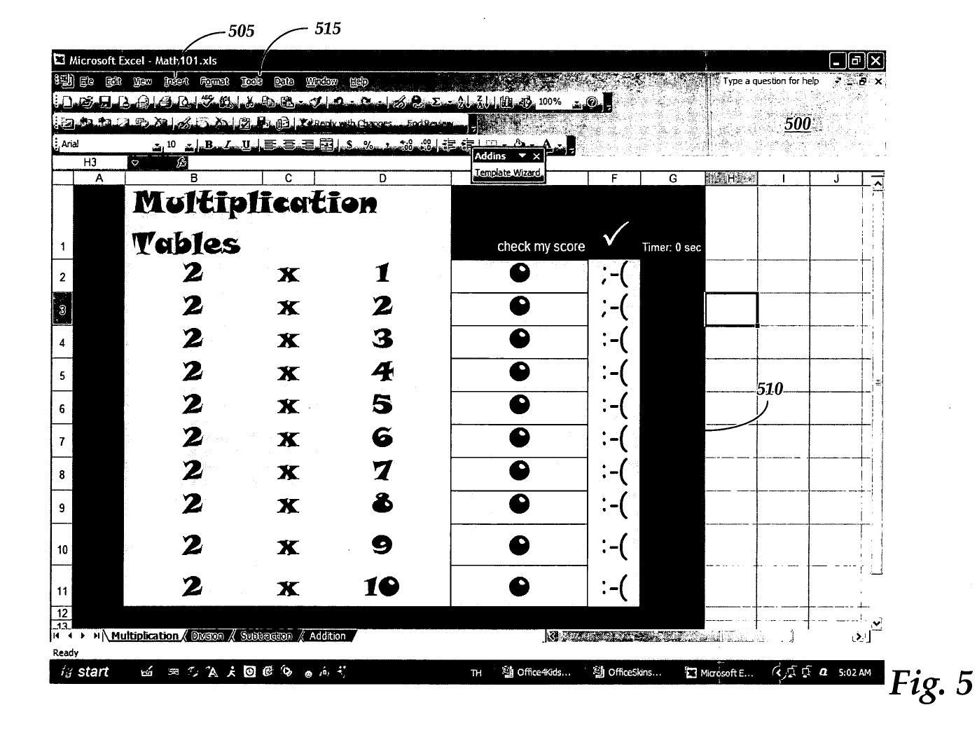

FIGS. 4 and 5 illustrate additional examples of customized user interface skins that may be used to overlay a standard user interface 200 according to embodiments of the present invention. For example, the user interface skin illustrated in FIG. 4 is a word processing application user interface skin for overlaying a standard word processing application user interface 200 illustrated in FIG. 2. The example user interface skin illustrated in FIG. 4 is directed to a young female user. For example, the icons utilized for new blank documents and open documents 425, 430, respectively, include female-gendered smiley face icons, so that the icons are pleasing to a young female target user. Other functionality controls such as the boldface functionality control 455 and the underlying functionality control 460 remain available in the customized user interface skin illustrated in FIG. 4, but other unwanted or undesirable functionality controls have been hidden from view and hidden from use.

Referring still to FIG. 4, sample content 450 made available by the customized user interface skin is illustrated. As mentioned above, in addition to providing a customized functionality control set, useful content may be provided via the customized user interface skin. For example, a “Learn the Alphabet” game is illustrated in FIG. 4 that may be exposed to the target user via the customized user interface skin overlaying the standard user interface 200. By selection of a functionality control associated with the “Learn the Alphabet” game, the game is exposed in the workspace area of the user interface to allow the young user to learn about the alphabet. As should be understood, many different types of content may be provided, including elementary mathematics training, art training, spelling training, and a variety of enjoyable games. On the other hand, for target users such as businesses, other types of content may be provided. For example, helpful business information may be provided such as how to prepare certain types of business documents like resumes, purchase orders, sales documents, inventory documents, and the like. The customized user interface skin illustrated in FIG. 5 is directed to a spreadsheet application. As illustrated in FIG. 5, a customized user interface skin 500 has been overlaid on a standard spreadsheet application user interface, and sample content has been provided for teaching a young target user how to use multiplication tables.

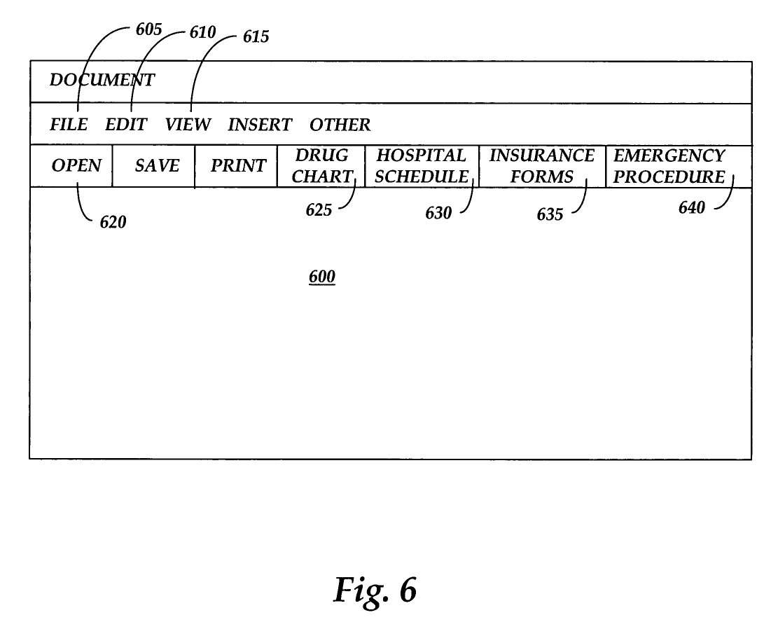

FIG. 6 is an illustration of a computer screen display showing a customized user interface skin overlaying a standard user interface and showing customized functionality sets created and exposed via a development wizard according to embodiments of the present invention. As illustrated in FIG. 6, a target user, such as a hospital institution, has utilized the development wizard described above to customize a user interface skin 600 for overlaying a standard word processing user interface 200. As illustrated in FIG. 6, in addition to the standard functionality controls provided in the standard user interface 200, additional controls particular to the hospital institution have been added. For example, a drug chart control 625 has been added for launching a word processing document or template associated with drug interaction charts. A hospital schedule control 600 has been added for launching functionality associated with preparation or display of hospital personnel schedules. An insurance forms control 635 has been added for launching or accessing documents or templates associated with hospital insurance forms. An emergency procedure control 640 has been added for providing access to emergency procedures needed by hospital personnel. As described above, while the customized user interface skin 600 overlays the standard user interface 200, only the functionality exposed to the target user by the overlaying customized user interface skin 600 is available to the user. If the user desires to return to the standard user interface set 200, the user may selectively dismiss the customized user interface skin 200 and return to the standard user interface 200.

As described herein, a customizable user interface for exposing customized application functionality sets is provided. By overlaying a standard user interface with a customized user interface skin, only a customized or desired functionality sets are exposed to and usable by a target user. If desired, the standard user interface may be selectively returned for use. It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. An improved user interface combination for exposing a customized application functionality set, comprising:
a user interface deployable by a software application, said user interface including a plurality of functionality controls which when selected invoke one or more functionalities of the software application;
a customized user interface skin overlaid onto the user interface, said user interface skin including a subset of the plurality of functionality controls which when selected invoke one or more functionalities of the software application; and
whereby when the customized user interface skin is overlaid onto the user interface, only functionality controls comprising the subset of functionality controls may be selected for invoking one or more functionalities of the software application.

2. The improved user interface combination of claim 1, whereby one or more functionality controls comprising the subset of functionality controls includes a visual icon for associating the one or more functionality controls with functionalities of the software application.

3. The improved user interface combination of claim 2, whereby the subset of the plurality of functionality controls are associated with a subset of the functionalities of the software application, said subset of the functionalities being associated with a target user group.

4. The improved user interface combination of claim 1, whereby at least one of the one or more functionality controls is associated with content, such that upon selection of the one or more functionality controls, the content is provided in a work space of the user interface skin.

5. The improved user interface combination of claim 3, whereby the target user group includes children.

6. The improved user interface combination of claim 3, whereby the target user group includes senior citizens.

7. The improved user interface combination of claim 3, whereby the target user group includes businesses.

8. The improved user interface combination of claim 3, whereby the target user group includes hospitals.

9. The improved user interface combination of claim 3, whereby the target user group includes schools.

10. A method of providing a customized user interface, comprising:
receiving an indication for launching a user interface associated with a software application;
displaying in the user interface a plurality of functionality controls which when executed invoke one or more functionalities of the software application;
overlaying onto the user interface a customized user interface skin including a subset of the plurality of functionality controls which when selected invoke one or more functionalities of the software application; and
when the customized user interface skin is overlaid onto the user interface, allowing only functionality controls comprising the subset of functionality controls to be selected for invoking one or more functionalities of the software application.

11. The method of claim 10, further comprising providing a visual icon for one or more of the functionality controls comprising the subset of functionality controls for associating the one or more functionality controls with functionalities of the software application where the visual icon is associated with a target user group.

12. The method of claim 10, further comprising associating the subset of the plurality of functionality controls with a subset of the functionalities of the software application that are associated with a target user group.

13. The method of claim 10, further comprising associating at least one of the one or more functionality controls with content such that upon selection of the one or more functionality controls, providing the content in a work space of the user interface skin.

14. The method of claim 10, after overlaying onto the user interface a customized user interface skin, providing a user interface development wizard for customizing the subset of the plurality of functionality controls.

15. The method of claim 14, further comprising providing the user interface development wizard for providing customized software application functionality and content that may be invoked upon selection of one or more of the subset of the plurality of functionality controls included in the user interface skin.

16. The method of claim 12, further comprising associating the subset of the functionalities with a target user group of children.

17. The method of claim 12, further comprising associating the subset of the functionalities with a target user group of senior citizens.

18. The method of claim 12, further comprising associating the subset of the functionalities with a target user group of businesses.

19. The method of claim 12, further comprising associating the subset of the functionalities with a target user group of hospitals.

20. The method of claim 12, further comprising associating the subset of the functionalities with a target user group of schools.

21. A computer-readable medium having stored thereon computer-executable instructions which when executed by a computer perform a method for providing a customized user interface, comprising:
receiving an indication for launching a user interface associated with a software application;
displaying in the user interface a plurality of functionality controls which when executed invoke one or more functionalities of the software application;
overlaying onto the user interface a customized user interface skin including a subset of the plurality of functionality controls which when selected invoke one or more functionalities of the software application; and
when the customized user interface skin is overlaid onto the user interface, allowing only functionality controls comprising the subset of functionality controls to be selected for invoking one or more functionalities of the software application.

22. The computer-readable medium of claim 21, further comprising providing a visual icon for one or more of the functionality controls comprising the subset of functionality controls for associating the one or more functionality controls with functionalities of the software application where the visual icon is associated with a target user group.

23. The computer-readable medium of claim 21, further comprising associating the subset of the plurality of functionality controls with a subset of the functionalities of the software application that are associated with a target user group.

24. The computer-readable medium of claim 21, further comprising associating at least one of the one or more functionality controls with content such that upon selection of the one or more functionality controls, providing the content in a work space of the user interface skin.

25. The computer-readable medium of claim 21, after overlaying onto the user interface a customized user interface skin, providing a user interface development wizard for customizing the subset of the plurality of functionality controls.

26. The computer-readable medium of claim 25, further comprising providing the user interface development wizard for providing customized software application functionality and content that may be invoked upon selection of one or more of the subset of the plurality of functionality controls included in the user interface skin.

27. The computer-readable medium of claim 23, further comprising associating the subset of the functionalities with a target user group of children.

28. The computer-readable medium of 23, further comprising associating the subset of the functionalities with a target user group of senior citizens.

29. The computer-readable medium of claim 23, further comprising associating the subset of the functionalities with a target user group of businesses.

30. The computer-readable medium of claim 23, further comprising associating the subset of the functionalities with a target user group of hospitals.

31. The computer-readable medium of claim 23, further comprising associating the subset of the functionalities with a target user group of schools.
